(19) United States
(12) Patent Application Publication
(10) Pub. No.: US 2012/0118823 A1
(43) Pub. Date: May 17, 2012

(54) ORGANOSILICATE BASED FILTRATION SYSTEM

(75) Inventors: Bakul C. Davé, Carbondale, IL (US); Carol Wood, Carbondale, IL (US)

(73) Assignee: SOUTHERN ILLINOIS UNIVERSITY CARBONDALE, Carbondale, IL (US)

(21) Appl. No.: 13/168,170

(22) Filed: Jun. 24, 2011

Related U.S. Application Data
(60) Provisional application No. 61/358,304, filed on Jun. 24, 2010.

(51) Int. Cl. B01D 71/06; B01D 69/06; B01D 69/10; B01D 61/02; B82Y 30/00

(52) U.S. Cl. 210/639; 210/500.27; 210/483; 210/499; 210/416.1; 210/653; 977/780

(57) ABSTRACT

Organosilicate compositions of variable charges, hydrophobicity, and porosity, and in particular organosilicate-based molecular filtration devices are disclosed.

### CROSS-REFERENCE TO RELATED APPLICATIONS

This is a non-provisional application that claims benefit to U.S. Provisional Application No. 61/358,304 entitled “Organosilicate Based Filtration System” filed on Jun. 24, 2010 the contents of which are hereby fully incorporated by reference.

### FIELD

This document relates to organosilicate compositions of variable charges, hydrophobicity, and porosity, and in particular to an organosilicate-based molecular filtration device.

### BACKGROUND

The use of porous materials as separation media has been widespread in chemical and biotechnology. These materials typically find useful applications in the separation of ions, molecules, gases, as well as biomolecules. Such separation strategies typically rely on size-selective properties imparted by the porous materials for shape-selective recognition and separation. As a result, typical separation processes are limited to those applications that require the use of specialized separation media with narrowly-defined adsorption affinities. The design of materials that can be used for a wide range of molecular separations remains a formidable challenge in the utilization of nanoporous materials and membranes for separation applications. Consequently, novel strategies for the design of separation materials and/or membranes with molecular level control over their properties that can be easily adapted for a diverse range of separation processes are particularly appealing.

In this direction, there have been several approaches that utilize inorganic materials and membranes in size-selective separations. Similarly, polymeric membranes have also been used in separation processes. An additional pathway to introduce selectivity in addition to shape and size has been the use of molecularly imprinted materials in separation. However, the utility of conventional membranes as viable materials is limited to certain size domains. While each of these approaches offers certain advantages, critical needs still exist for development of new materials that can exhibit multimodal recognition pathways for efficient separation. In addition, typical membranes exhibit passive transport of solutes and the design of materials with properties capable of modulation through the application of external physicochemical stimuli offer prospects for the development of next-generation “smart” or “intelligent” membranes that can perhaps achieve or at least rival the exquisite selectivity, control, and regulation exhibited by their biological counterparts.

### SUMMARY

In an embodiment, a molecular filtration device is provided that includes at least one membrane filter element. The at least one membrane filter element includes an organosilicate material.

In another embodiment, filtration membrane disc is provided that includes an organosilicate material in the form of a sol-gel.

In yet another embodiment, a method of removing a molecule from an aqueous solution that includes the molecule is provided. This method includes introducing the aqueous solution into a molecular filtration device that includes at least one filtration element that incorporates an organosilicate material.

Additional objectives, advantages and novel features will be set forth in the description which follows or will become apparent to those skilled in the art upon examination of the drawings and detailed description which follows.

### BRIEF DESCRIPTION OF THE DRAWINGS

The following figures illustrate various embodiments of the invention.

FIG. 1 is an illustration of an embodiment of a molecular filtration device;

FIG. 2A is an illustration of an embodiment of a positive-pressure molecular filtration device;

FIGS. 2B and 2C are illustrations of embodiments of syringe filter devices;

FIG. 3 is a graph of the UV-Vis spectra taken before and after the addition of carboxylate particles to a methylene blue dye solution and a phenol red dye solution both singly and in mixture;

FIG. 4 is a graph of the UV-Vis spectra taken before and after the addition of carboxylate particles to a methylene blue dye solution and a phenol red dye solution both singly and in mixture;

FIG. 5 is a graph summarizing the UV-Vis spectra taken before and after the addition of enTMOS particles to a methylene blue dye solution and a phenol red dye solution both singly and in mixture;

FIG. 6 is a graph summarizing the UV-Vis spectra taken before and after the addition of enTMOS particles to methylene blue and methyl red both singly and in mixture;

FIG. 7 is a graph illustrating the absorption kinetics of carboxylate and enTMOS nanoparticles placed in mixtures of methylene blue dye and phenol red dye;

FIG. 8 is a graph illustrating the absorption kinetics of carboxylate and enTMOS nanoparticles placed in mixtures of methylene blue dye and methyl red dye;

FIG. 9 is a graph illustrating the absorption kinetics of carboxylate nanoparticles combined with rhodamine dye;

FIG. 10 is a graph illustrating the absorption kinetics of enTMOS nanoparticles combined with pyranine dye;

FIG. 11 is a graph illustrating the UV-Vis spectra of methylene blue/phenol red dye mixes before and after filtration through a carboxylate syringe filter; and

FIG. 12 is a graph illustrating the UV-Vis spectra of methylene blue/phenol red dye mixes before and after filtration through a DT syringe filter.

Corresponding reference characters indicate corresponding elements among the view of the drawings. The headings used in the figures should not be interpreted to limit the scope of the claims.

### DETAILED DESCRIPTION

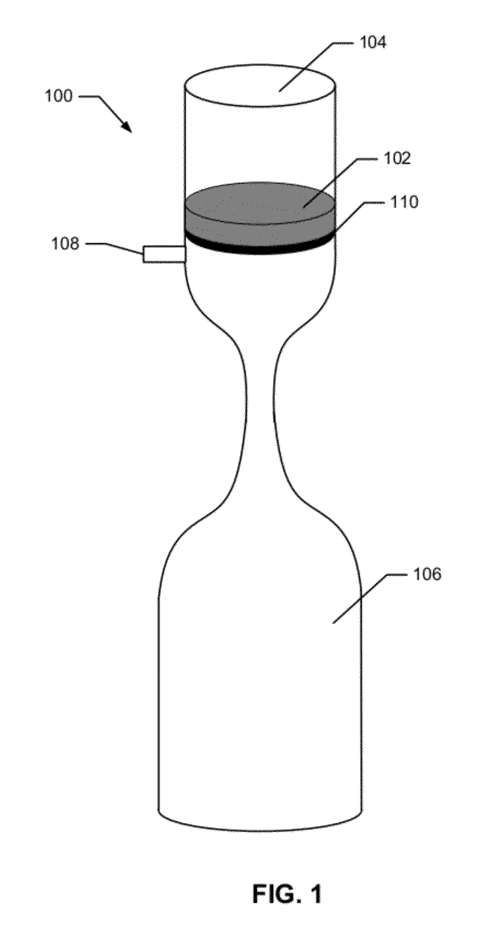

Referring to the drawings, an embodiment of a molecular filtration device is illustrated and generally indicated as 100 in FIG. 1. The molecular filtration device 100 may include at least one membrane filter element 102. This membrane filter element 102 comprises an organosilicate material. The use of the organosilicate material overcomes at least several limitations of existing molecular filtration materials.

### I. Organosilicate Materials

The organosilicate materials can be processed in various forms, including but not limited to powdered forms including microparticles and nanoparticles, bulk gel forms, or in the form of membranes or coatings. The organosilicate materials contain both organic as well as inorganic fractions that impart properties that are similar to ceramics and polymers. Like ceramics, organosilicate gels are mechanically stable, but in addition are considerably elastic and flexible like polymers. Organosilicate gels exhibit intrinsic selectivity for particular molecules including but not limited to biomolecules, which can be further tuned, controlled, and regulated by the application of different external stimuli including but limited to pH, temperature, salt content of the solvent containing the molecules to be filtered, and applied external electrical fields. The organosilicate materials also exhibit selective interactions with biomolecules based on their intrinsic properties such as electrical charge and hydrophobicity, depending on the specific composition of the organosilicate material. Taken together, the environmentally responsive sol-gels furnish several physicochemical characteristics that may be effectively utilized in separation processes based on selective molecular recognition.

The organosilicate materials used in the molecular filtration devices 100, as well as methods of making the organosilicate materials, are described in detail in U.S. Pat. No. 6,756,217, which is hereby incorporated by reference in its entirety. In brief, the organosilicate materials include any material having the general formula:

(OR¹)₃—Si-(spacer)-Si—(OR²)₃ (I)

where:

R¹ and R² are independently chosen from hydrogen, alkyl, alkenyl, alkynyl, or aryl groups; and
the spacer comprises an organic unit, an inorganic unit, a biological unit, or any combination thereof.

Non-limiting examples of specific organosilcate materials suitable for producing a membrane filter element 102 include tetramethyl orthosilicate (TMOS), tetraethyl orthosilicate (TEOS), bis[3-(trimethoxysilyl)propyl]ethylenediamine (enTMOS),3-trimethylsilylpropyl diethylenetriamine (DT), carboxylethylsilanetriol (carboxylate), 3-aminopropyl trimethoxysilane, 3-(triethoxysilyl)propyl succinic anhydride, 3-trihydroxysilylpropylmethylphosphonate, 3-(trihydroxysilyl)-1-propanesulfonic acid and any combination thereof. In an embodiment, the tetraalkoxy orthosilicate precursors such as tetramethoxysilane and tetraethoxysilane may be used as network formers to provide structure to the membrane filter element 102. In another embodiment, a particular organosilicate material may be selected in order to enhance the affinity of the membrane filter element 102 for the molecule to be filtered from an aqueous solution that includes the molecule. The affinity of the membrane filter element 102 for the molecule to be filtered may be enhanced by the manipulation of the chemical properties of the membrane filter element 102, including but not limited to electrostatic charge, hydrophobicity, and any combination thereof.

A particular mixture of organisilicate materials may be selected to produce a membrane filter element 102 with a desired electrostatic charge. To this end, the organosilicate materials may be produced using any combination of positively-charged or negatively-charged precursors. Non-limiting examples of suitable positively-charged precursors include precursors that include amino groups, and non-limiting examples of suitable negatively-charged precursors include precursors having carboxylate, phosphonate, and/or sulfonate groups. In an embodiment, a membrane filter element 102 with a desired electrostatic charge may be produced by mixing one or more positively-charged precursors and one or more negatively-charged precursors in variable ratios depending upon the properties of the molecule to be isolated using the membrane filter element 102. The mass ratio of positively charged precursors:negatively charged precursors may vary from 0:100 (purely positively-charged) to 100:0 (purely negatively-charged).

The particular mixture of organisilicate materials may be selected to produce a membrane filter element 102 with a desired hydrophobicity. To this end, the organosilicate materials with a desired hydrophobicity may be produced using a precursor that include hydrophobic groups having the general formula:

(OR³)₃—Si—(OR⁴)₃ (II)

where:
R³ is a hydrocarbon chain with 1 to 18 carbon atoms and R⁴ is a is methyl, ethyl, isopropyl or t-butyl group.

The organosilicate material used to construct the membrane filter element 102 may be provided in the form of a sol-gel. The sol-gel forms of the organosilicates impart additional capabilities to the membrane filter element 102 wherein the ability to selectively separate different molecules may be tuned through application of one or more externally applied stimuli. These externally applied stimuli may modulate changes in the physical and chemical properties of the membrane filter element 102 including but not limited to porosity, hydrophobicity, electrostatic charge, and hydrogen bonding interactions. These attributes make the porous organosilicate sol-gels a particularly useful system for filtration applications due to combined selectivity based on physical characteristics including but not limited to the shape and size of the molecule to be removed from the solution, as well as chemical properties including but not limited to hydrophobicity, charge, and hydrogen bonding interactions of the molecule.

The environmentally sensitive sol-gel organosilicate membranes provide several unique advantages. Overall, the process of filtration using the organosilicate materials as a membrane filter element 102 is based on selective interactions of the molecules with the organosilicate membrane material. The organosilicate sol-gels selectively intake molecules that are characterized by favorable interactions while the organosilicate sol-gels selectively expel and release molecules that are incompatible with the physical and chemical characteristics of the organosilicate sol-gel material. This unique feature of the organosilicate sol-gel materials establishes facile transport pathways for the selective diffusion of the molecules to be removed from a solution while at the same retarding the diffusion, permeation, and/or transport of other molecules. The combined effect of these two steps results in the characterization of the membrane filter element 102 incorporating the organosilicate sol-gel materials as active separation membranes. An essential requirement in the use of these organosilicate sol-gel materials as membranes for separation depend upon selective and facilitated diffusion, permeation, transport, recognition, and separation of molecules based on their size, shape, charge, hydrophobicity, and hydrogen bonding interactions.

Existing membrane filter materials separate molecules based on the size and shape of the molecules, which may limit the membrane filter's effectiveness in separating molecules with similar sizes. The organosilicate materials used in the construction of the membrane filter element 102 overcomes this limitation of previous membrane filter materials by providing a dual-mode separation process based on size as well as interactions.

The molecular filtration device 100 described herein represents a novel approach to separation processes that, to a certain extent, mimic those found in biological membrane based on active regulation of molecular recognition, allosteric effects, and selectivity that are utilized to maintain active concentration gradients in biological systems. As opposed to existing passive membrane systems, the organosilicate sol-gel materials of the membrane filter element 102 are characterized by active interactions that can be further tuned by means of externally applied stimuli, thereby imparting the capability to selectively separate structurally analogous molecules including but not limited to biomolecules.

### II. Molecular Filtration Devices

Referring back to FIG. 1, the molecular filtration device 100 includes the membrane filter element 102 situated within a sample inlet 104. The sample inlet 104 may be any existing inlet device including but not limited to a funnel, a membrane filter support device, a syringe barrel, and a fitting for a pipe or tube for delivering solution to the molecular filtration device 100 or any other known suitable inlet device. In one embodiment, the membrane filter element 102 may be situated within the sample inlet 104.

In addition to the membrane filter element 102, the molecular filtration device 100 may further include a lower membrane support 110 and an upper membrane support (not shown). The lower membrane support 110 and the upper membrane support may provide structural integrity to the membrane filter element 102. The lower membrane support 110 and the upper membrane support are typically porous to allow the passage of the solution containing the molecule to be filtered through the membrane filter element 102. Non-limiting examples of suitable lower membrane support 110 or upper membrane support include a frit, a mesh, a screen, a fabric, and a porous membrane.

For example, if the organosilicate material of the membrane filter element 102 is provided in a particulate such as a powder, the organosilicate material may be sandwiched between the lower membrane support 110 and the upper membrane support in the molecular filtration device 100.

The organosilicate material typically includes a plurality of pores through which the solution may pass when performing molecular filtration to remove the molecule from the solution. In one embodiment, the pores may have pore diameters ranging from about 1 nm to about 100 nm. In another embodiment, the pore diameters range from about 1 nm to about 20 nm.

The membrane filter element 102 may be incorporated in the form of a disk having a thickness ranging from about 1 mm to about 1 cm. The disk may be of any diameter, so long as a suitably large membrane support structure is also incorporated into the design of the molecular filtration device 100. For example, a commercially-available filter holder such as those produced by Millipore, Inc. (Billerica, Mass., USA) may be used to support a membrane filter element 102. The dimensions of the membrane filter element 102, such as filter diameter, may be sized to fit into a commercially-available filter holder.

Referring again to FIG. 1, the molecular filtration device 100 may further include a container 106 to collect the filtered solution after it has passed through the membrane filter element 102. The flow rate of the solution through the membrane filter element 102 may be enhanced by the application of negative pressure or vacuum to the volume of the container 106 by way of a vacuum inlet 108.

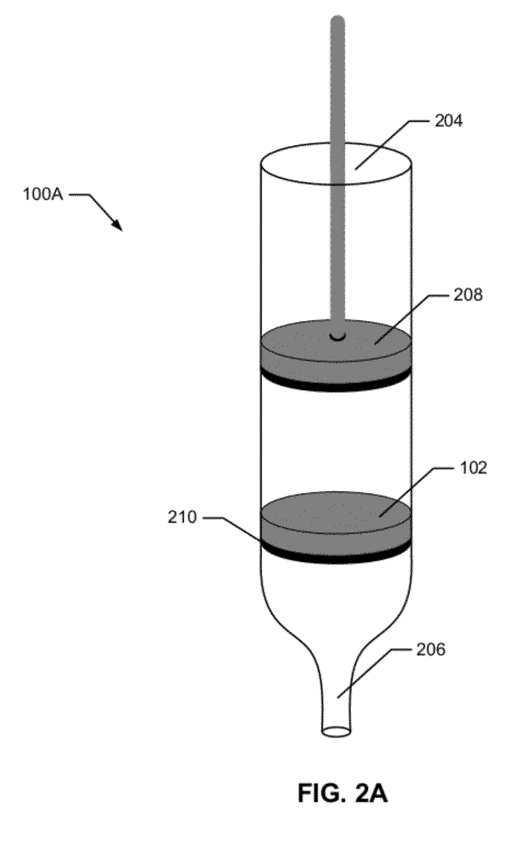

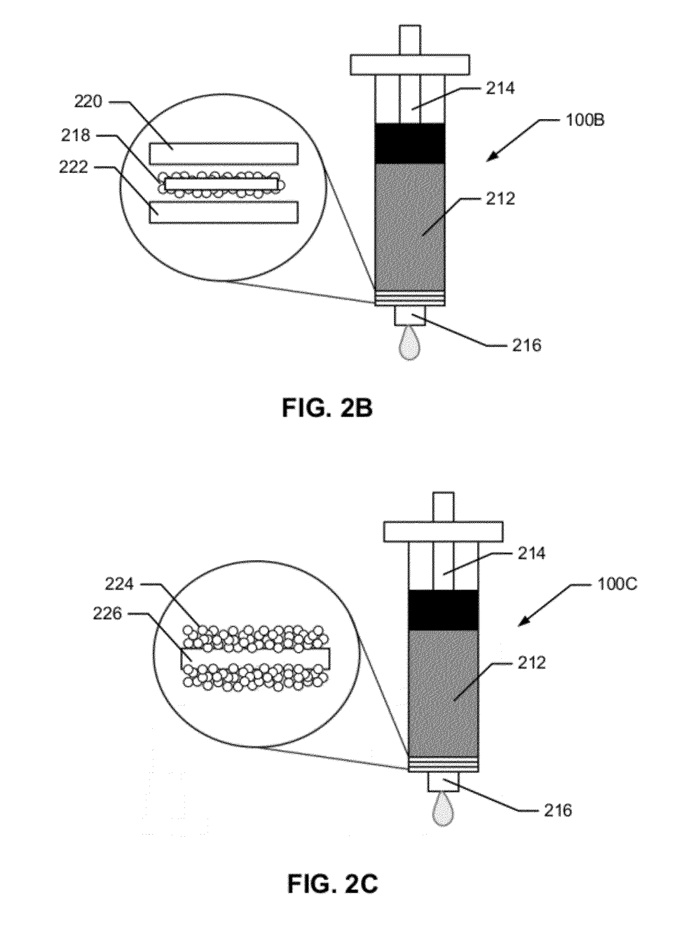

In another embodiment, the flow rate of the solution through the molecular filtration device 100A may be enhanced by the application of positive pressure to the volume of the sample inlet 104. FIG. 2A illustrates another embodiment of a molecular filtration device 100A in which a piston 208 is used to apply positive pressure to the volume within the sample inlet 204. In this embodiment, the filtered sample may exit the molecular filtration device 100A through a sample outlet 206, which may open out to the atmosphere to reduce the backpressure on the molecular filtration device 100A within the volume opposite to the volume of the sample inlet 104. Alternatively, the volume adjacent to the sample outlet 206 may be connected to a vacuum source (not shown) to further enhance the flow rate of the solution through the membrane filter element 102.

For example, the molecular filtration device 100 may be a syringe filter 100B, illustrated in FIG. 2B. In this example, the sample inlet 204 may be a syringe barrel 212, the piston 208 may be a syringe plunger 214, and the sample outlet 206 may be the exit of the syringe 216. In this embodiment, the organosilicate material making up the membrane filter element 102 may be provided in the form of particles 218 or powder sandwiched between an upper substrate 220 and a lower substrate 222 situated in the bottom of the syringe barrel 212. In another embodiment of a syringe filter 100C, illustrated in FIG. 2C, the organosilicate material making up the membrane filter element 102 may be provided as a coating 224 on a substrate 226 and situated in the bottom of the syringe barrel 212. Non-limiting examples of suitable substrate materials for a syringe filter 100B or 100C include filter paper, fabric, screen, and frit.

In other embodiments, the molecular filtration device 100 may be a filter structure that is coated with an organosilicate material. Non-limiting examples of suitable filter structures include a frit, a mesh, a screen, paper, fabric, cellulose fibers, wool pads, polymeric membranes, and ceramic disks. In this embodiment, the organosilicate material may be dissolved into a solvent including water, an organic solvent, or combinations thereof. The dissolved organosilicate material may be coated on the filter structure by any known method, including but not limited to painting the dissolved organosilicate material onto the filter structure, spraying the dissolved organosilicate material onto the filter structure, and dipping the filter structure into the dissolved organosilicate material.

### III. Methods of Molecular Filtration

The molecular filtration devices 100 described herein may be used to selectively remove a molecule from an aqueous solution that includes the molecule. Non-limiting examples of molecules suitable for separation using the molecular filtration device 100 include any molecule including biomolecules such as proteins and enzymes. Suitable molecules may have molecular weights ranging from about 10,000 Daltons to about 100,000 Daltons.

In various embodiments of molecular filtration methods using the molecular filtration devices 100 described herein, a solution containing the molecule to be removed from the solution may be introduced into the molecular filtration device 100, in which the molecular filtration device 100 includes a filtration element made of an organosilicate material.

The physical and/or chemical properties may be specified by the selection of the particular organosilicate material as described herein above. In addition, the attractive interactions of the organosilicate material in a sol-gel form with the molecules in the solution during molecular filtration may be modulated by the application of one or more external stimuli to the organosilicate material in the filtration element. Non-limiting examples of suitable external stimuli for the modulation of the physical and chemical properties of the filtration element include pH of the aqueous solution, temperature of the aqueous solution, concentration of dissolved salts in the aqueous solution, an electrical field applied to the organosilicate material, a magnetic field applied to the organosilicate material, and any combination thereof.

Any of the molecular filtration devices 100 described herein above may be used in various embodiments of the molecular filtration methods, including but not limited to a vacuum filter incorporating a organosilicate membrane filter, and a syringe filter incorporating particulate organosilicate material sandwiched between upper and lower filter paper disks.

Additional examples of the molecular filtration devices 100 and methods of using the molecular filtration devices 100 are provided in the Examples below.

### EXAMPLES

### Example 1

### Separation of Solutes Using Electrostatically-Charged Nanoparticles

To demonstrate the feasiblity of selectively separating a solute from an aqueous solvent using electrostatically-selective nanoparticles, the following experiment was conducted. Nanoparticles with different electrostatic charges in aqueous solution were used to selectively absorb dye particles from a mixture of dye molecules having different electrostatic charges.

A quantity of enTMOS nanoparticles, which exhibited a positive electrostatic charge in aqueous solution, were produced for use in this experiment. A batch of the enTMOS nanoparticles was formed by combining 400 μL of bis[3-(trimethoxysilyppropyl]ethylenediamine precursor (Gelest, Inc., Morrisville, Pa., USA) with 50 mL of de-ionized water and stirring with a magnetic stirring rod for 20 minutes. The resulting solution was initially a clear brown color (due to the brown color of the enTMOS precursor) but eventually became lighter and more turbid, indicating that a suspended particulate precipitate had formed. After stirring, the solution was allowed to settle, the supernatant solution was poured off, and the remaining precipitate was filtered out using a vacuum filter. The resulting precipitate was then dried in a 53° C. oven for at least one hour and then ground with a ceramic mortar and pestle until uniform. The resulting enTMOS nanoparticles had a slightly yellowed appearance due to the coloring of the enTMOS precursor.

A quantity of carboxylate nanoparticles, which exhibited a negative electrostatic charge in aqueous solution, were also produced for use in this experiment. A batch of the carboxylate nanoparticles was formed using a sol-gel method. A solution of 3 mL TMOS, 0.8 mL de-ionized water, and 0.044 mL of 0.04M HCL was sonicated for 20 minutes. 3.5 mL of the sonicated solution was then placed in a 15 mL polyethylene beaker and 1.75 mL of carboxylate precursor was added while stirring with a magnetic stirring rod. The solution immediately turned from a clear liquid to a clear gel upon addition of the carboxylate precursor. The clear gel was allowed to sit uncovered at room temperature for approximately 24 hours. After this time the gel turned a translucent white color and was subsequently broken up with a metal spatula, roughly ground with a mortar and pestle, and allowed to sit in a 53° C. oven for 45 minutes. Once fully dry the gel was ground thoroughly, thereby yielding fine white TMOS nanoparticles with a powdery texture.

The nanoparticles were coated onto glass microscope slides (Fisherfinest Premium slides, Fisher Scientific, Pittsburgh, Pa., USA). The slides were first soaked in a NoChromix solution overnight then rinsed with tap water and acetone and allowed to dry. The slides were then cut to the desired sizes using a scoring and breaking technique and arranged horizontally. A coating solution of 75 mg of either enTMOS or TMOS nanoparticles suspended in 2.5 mL of de-ionized water was droppered into the slides using a disposable pipette. This coating was allowed to dry for at least 24 hours before the slides were used.

A mixture of positively-charged and negatively-charged dye molecules was formed to test the selective absorptive properties of the enTMOS and carboxylate nanoparticles. 5 mL of a solution consisting of 50% by volume 0.05 mM methylene blue dye (positively-charged) and 50% by volume 0.05 mM phenol red dye (negatively-charged) in aqueous solution was placed into each of two 15 mL plastic beakers. A carboxylate-coated slide was placed next to one beaker and an enTMOS-coated slide was placed next to the other beaker and a “before” photograph was obtained to document the color of the slides as well as the color of the dye solutions prior to any contact of the slides with the dye mixture.

The carboxylate-coated slide was completely submerged in the dye solution at the bottom of one beaker, and the enTMOS-coated slide was similarly situated in the other dye-filled beaker. The beakers were allowed to sit undisturbed for approximately 20 minutes, after which the slides were removed and an “after” photograph was taken to record any color change in the slides and/or dye solution.

Initially, the dye solutions were green in color due to the orange/yellow color of the diluted phenol red solution combined with the blue color of the diluted methylene blue solution. After the carboxylate-coated slide was added to one beaker, the dye solution in this beaker immediately turned dark blue/purple. This rapid color change was likely caused by an increase in pH of the dye mixture caused by the addition of highly basic carboxylate, which in turn induced a color change in the pH-sensitive phenol red. This effect was confirmed by the observation of a similar color change due to the addition of NaOH solution to a similar mixed dye solution.

After 20 minutes of exposure to the dye solution, both slides showed distinct color changes due to the selective absorption of the dyes in the dye solution. The carboxylate-coated slides changed from a white to a blue color due to the absorption of positively-charged methylene blue dye by the negatively-charged carboxylate nanoparticles. The enTMOS-coated slides changed from a yellowish-white to a red/pink color due to the absorption of negatively-charged phenol red dye by the positively-charged enTMOS nanoparticles. In both beakers, no discernable change in the color of the dye solutions was observed after the selective absorption of dyes by the nanoparticle-coated slides. This lack of discernible color change in the beakers was most likely due to the high concentration of the dye solutions necessary to ensure a visible change in the nanoparticle color.

Similar experiments were conducted using the carboxylate-coated slides and enTMOS-coated slides in mixtures of methylene blue dye/methyl red dye, with similar results. The carboxylate nanoparticles again absorbed the positively-charged ethylene blue, and the enTMOS nanoparticles absorbed the negatively-charged methyl red. In this experiment, no change in color was observed immediately after the addition of the carboxylate-coated slide to the dye mixture. This lack of color change was likely due to the color sensitivity of methyl red to decreases in pH, rather than increases in pH, such as the pH change induced by the introduction of a carboxylate-coated slide. No discernable change in the color of the dye solutions was observed after the selective absorption of dyes by the nanoparticle-coated slides.

A third set of experiments were conducted using the carboxylate-coated slides and enTMOS-coated slides in mixtures of fluorescent dyes (pyranine dye/rhodamine dye), with similar results. In this experiment, fluorescent “before” and “after” photographs were obtained using a long wave UV lamp (BlakRay Model B, UVP, Inc., Upland, Calif., USA) for illumination. The positively-charged enTMOS nanoparticles absorbed the negatively-charged yellow/green pyranine dye, and the negatively-charged carboxylate particles absorbed the positively-charged red rhodamine dye. Although the carboxylate nanoparticles exhibited a slight red fluorescence initially, the intensity and color of the florescence changed greatly after the absorption of the rhodamine dye. A significant amount of flaking of the nanoparticle coatings from the slides was observed during these experiments, which was likely due to the heat generated by the UV lamp used to obtain the fluorescent photographs. In the previous experiments in which the dye solutions and slides were not subjected to this heat, flaking was negligible.

The results of this experiment demonstrated the feasibility of separating a mixture of solute molecules using the absorption by nanoparticles having different electrostatic charges.

### Example 2

### Separation of Solutes Using Mixtures of Electrostatically-Charged Nanoparticles

To demonstrate the feasiblity of selectively separating two solutes from an aqueous solvent using a mixture of electrostatically-selective nanoparticles, the following experiment was conducted. A mixture of nanoparticle absorbents with different electrostatic charges in aqueous solution was used to selectively absorb dye particles from a mixture of dye molecules having different electrostatic charges.

Carboxylate-coated slides and enTMOS-coated slides were produced using the methods described in Example 1, and a 15 mL plastic beaker was filled with a dye mixture of 7.5 mL of 0.05 mM methylene blue and 7.5 mL of 0.05 mM phenol red. A “before” photograph was obtained to document the colors of the slides and the dye mixture in the beaker, and then both the carboxylate-coated slide and the enTMOS-coated slide were placed in the beaker such that the two slides were submerged in the dye solution and leaning upright against opposite sides of the beaker. After 20 minutes, both slides were removed from the beaker and an “after” photograph was taken to document any color change in the slides and/or dye solution. This experiment was repeated with a methylene blue/methyl red mixture and a pyranine/rhodamine mixture using the techniques similar to those described in Example 1.

Similar results to those obtained in Example 1 were observed for these experiments. The carboxylate-coated slides selectively absorbed the methylene blue and rhodamine dyes, and the enTMOS-coated slides selectively absorbed the phenol red, methyl red, and pyranine dyes. The presence of both nanoparticles in the same dye solution did not appear to inhibit the selective absorption of the dyes in any experiment.

The results of this experiment demonstrated the feasibility of separating two or more different molecules from an aqueous solution using a mixture of nanoparticles with different electrostatic properties.

### Example 3

### Spectrographic Measurements of Solute Absorption Using Electrostatically-Charged Nanoparticles

To measure the reduction in dye concentration due to the absorption of dye molecules by electrostatically-charged nanoparticles, the following experiments were conducted. Absorption spectrographic measurements were performed on various dye compositions before and after contacting the compositions with absorptive nanoparticles to assess the reduction in dye concentration due to the absortion of dye by the nanoparticles.

Three cuvettes (clear-sided FisherBrand 4, Fisher Scientific, Pittsburgh, Pa., USA) were filled with the following solutions: 1) 3 mL of 0.05 mM phenol red; 2) 3 mL of 0.05 mM methylene blue; and 3) a mixture of 1.5 mL of 0.05 mM methylene blue and 1.5 mL of 0.05 mM phenol red. An initial spectrum of the dye solution in each cuvette was obtained using a spectrometer (Agilent 8453 UV-Visible Spectrometer, Agilent Technologies, Waldbronn, Germany). Carboxylate nanoparticles produced using methods similar to those described in Example 1 were obtained and divided into 25-mg samples. The 25-mg samples of carboxylate nanoparticles were added to each cuvette and shaken for 30 seconds, and then each cuvette was allowed to sit for one hour. A 1.5-mL aliquot of the dye solution was transferred from each cuvette into a 1.5 mL Eppendorf tube and centrifuged for 3 minutes to separate the nanoparticles from the dye solution. The supernatant dye solution was pipetted out of the Eppendorf tubes into three fresh cuvettes and spectra were obtained for each of the three dye solutions.

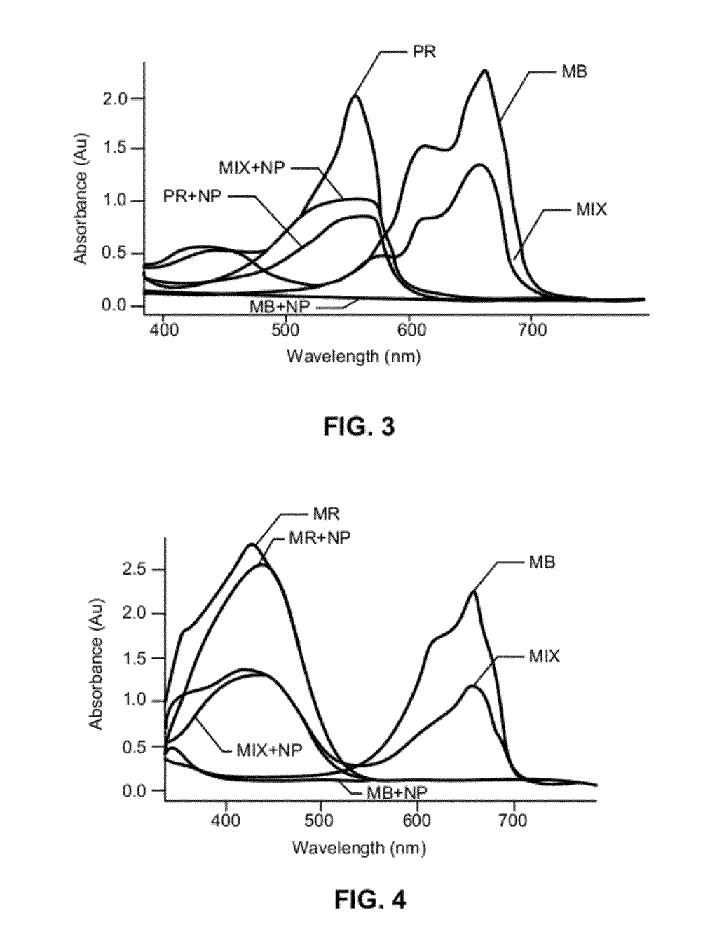

FIGS. 3 and 4 summarize the spectra obtained during this experiment. The UV-Vis spectrum taken before and after the addition of carboxylate nanoparticles to the two dye combinations demonstrated that the negatively charged carboxylate nanoparticles were able to interact with and absorb the positively charged methyl blue dye but not the negatively charged phenol red and methyl red dyes. In both FIG. 3 and FIG. 4, the blue spectral peaks (right hand double peaks, labeled MB) of the pure methylene blue solution were completely eliminated after the addition of the carboxylate nanoparticles (see spectra marked MB+NP in FIG. 3 and FIG. 4). However, when carboxylate nanoparticles were placed in the solution of pure phenol red (spectrum marked PR in FIG. 3) or methyl red (spectrum marked MR in FIG. 4), the red spectral peaks (left hand side) were decreased by far less (see PR+NP spectrum in FIG. 3 and MR+NP spectrum in FIG. 4 respectively). This decrease in the concentration observed in the red dyes was likely due to an effect of diffusion on the concentration of the dyes rather than any active interactions with the carboxylate particles with the red dyes. The interactions of the methylene blue dye with the carboxylate nanoparticles were likely not simple diffusion because the decreases in spectral peak heights due to the addition of the carboxylate nanoparticles were far more significant. When carboxylate particles were added to a mixture of dyes (see the spectrum marked MB/PR in FIG. 3 and MB/MR in FIG. 4) only the right-most spectral peaks corresponding to the methylene blue dye decreased significantly after exposure to the carboxylate nanoparticles (see spectrum marked MB/PR+NB in FIG. 3 and spectrum marked MB/MR+NP in FIG. 4). Essentially all of the methylene blue dye was absorbed by the carboxylate nanoparticles and the phenol red and methyl red dyes were left in solution.

A spectral peak shift was observed in the methylene blue/phenol red dye experiments. This was likely due to the pH sensitive nature of the phenol red. In isolation, phenol red dye was slightly basic which shifted the spectral peak to the right. When combined with methylene blue, which was not as basic, the pH of the dye mixture decreased, inducing a shift in the spectral peak for phenol red to the left. However, when basic carboxylate particles were added to the mixture, the pH of the mixture increased, thereby inducing a spectral peak shift of the phenol red dye to the right. This spectral peak shift was not observed in the trials with methylene blue/methyl red dyes, likely because methyl red dye is not known to change color in response to basic pHs.

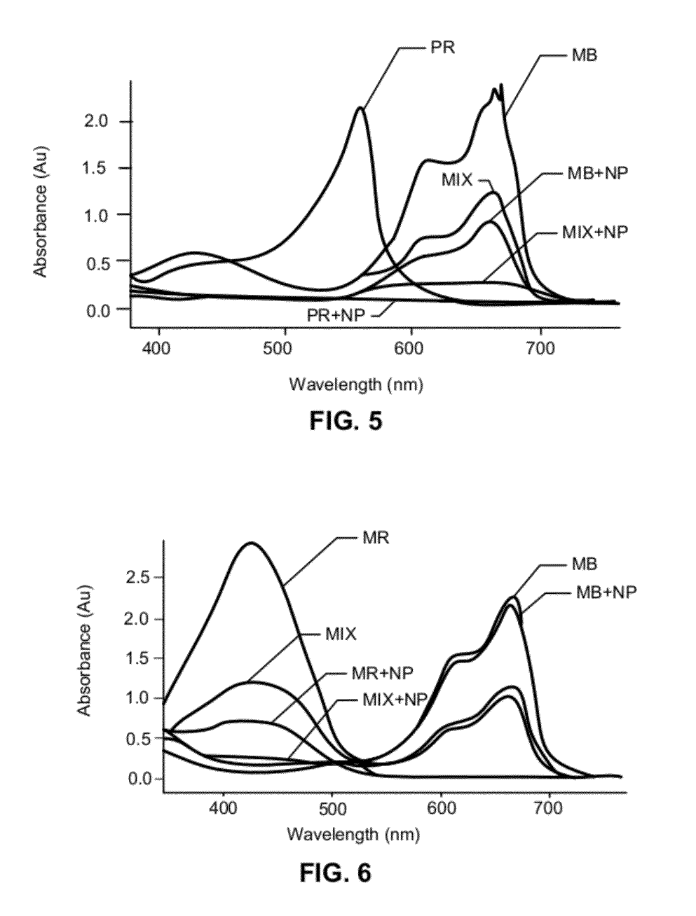

This experiment was repeated with enTMOS nanoparticles produced using methods similar to those described in Example 1, in place of carboxylate nanoparticles for the adsorbent. FIG. 5 and FIG. 6 summarize the spectra observed for combinations of methyl blue and phenol red, and combinations of methyl blue and methyl red, respectively. Evidence of selective absorption of the negatively-charged phenol red and methyl red dyes by the positively-charged enTMOS nanoparticles was observed. In pure solutions of the phenol red dye (PR in FIG. 5) and methyl red dye (MR in FIG. 6), the addition of enTMOS essentially eliminated these dyes (see spectrum marked PR+NP in FIG. 5 and MR+NP in FIG. 6). In mixed dye compositions (MB/PR in FIG. 5 and MB/MR in FIG. 6) only the left hand spectral peaks corresponding to phenol red and methyl red showed any significant decrease (see MB/PR+NP in FIG. 3 and MB/MR+NP in FIG. 6). Similar to the carboxylate experiment, there was a decrease in the intensity of the methylene blue spectral peaks, but again this was likely due to a diffusion effect and not from any specialized interactions.

### Example 4

### Kinetics of Solute Absorption by Electrostatically-Charged Nanoparticles Using Time-Dependent Spectroscopy

To assess the kinetics of the reduction in dye concentration due to the absorption of dye molecules by electrostatically-charged nanoparticles, the following experiments were conducted. Absorption spectroscopic measurements were obtained on various dye compositions at multiple time intervals after contacting the compositions with absorptive nanoparticles to assess the time course of the reduction in dye concentration due to the absorption of dye by the nanoparticles.

A cuvette was filled with a dye mixture consisting of 1.5 mL of 0.05 mM methylene blue and 1.5 mL of 0.05 mM phenol red. Two carboxylate-coated slides similar to those used in Example 1 were placed on opposite sides of the cuvette and allowed to sit in the dye solution. Every five minutes, the slides were removed, a UV-Vis spectrum was obtained, and then the carboxylate-coated slides were replaced in the cuvette. The measurements were obtained over the course of about one hour. The experiment was then repeated with enTMOS-coated slides similar to those used in Example 1.

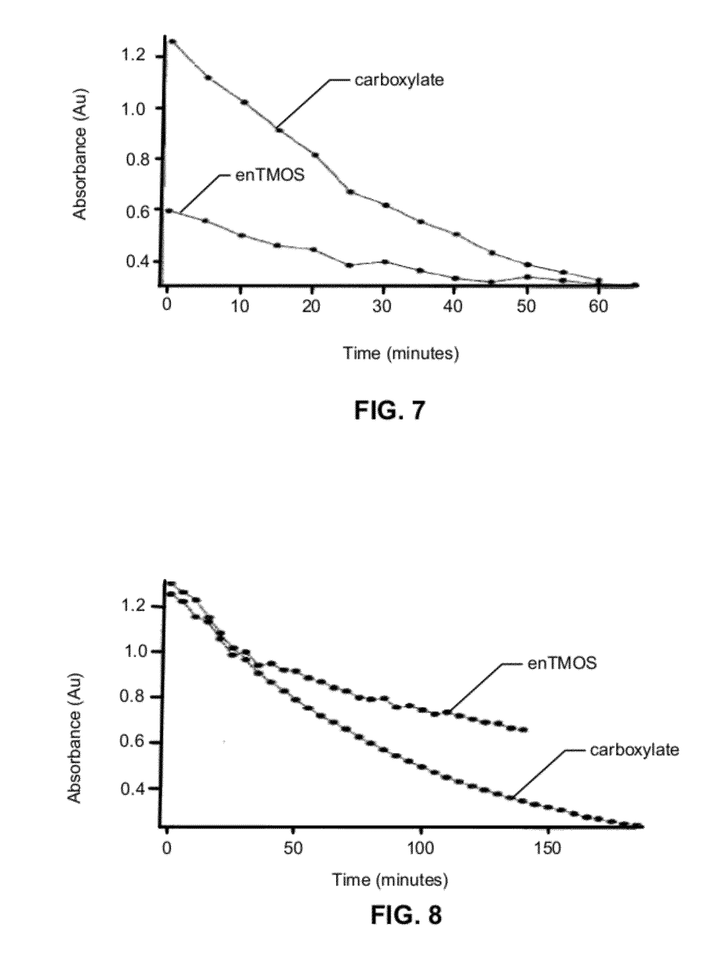

FIG. 7 is a graph summarizing the reduction in spectral peaks obtained from the methylene blue/phenol red dye mixture after contacting the carboxylate-coated slides (see line marked carboxylate) and the enTMOS-coated slides (see line marked enTMOS) over the course of about one hour. These data indicated that both absorbents absorbed dye in a concentration-dependent manner. After an initial rapid reduction of the dye intensity, the absorption of the dye proceeded at progressively slower rates as the dye concentration was reduced. Ultimately, the dye concentrations asymptotically approached zero at the end of the one-hour time period.

These experiments were repeated using a methylene blue/methyl red mixture. In this experiment, the nanoparticle-coated slides were not removed in between measurements, in order to avoid excess noise around the methyl red spectral peaks. The slides were positioned inside the cuvettes in such a way that they remained in the cuvette while spectral measurements were obtained without interfering with the measurements. The experiments were conducted for approximately 2.5 hours in an attempt to capture the complete absorption timeline. Similar results were obtained for the methylene blue and methyl red dye experiments, as summarized in FIG. 8.

Another set of experiments was repeated using fluorescent dyes. Due to limitations of the fluorescent spectrometer and complications with pH shifts, the fluorescent time trials involved the use of a single dye with each nanoparticle rather than a mixture of dyes.

3 mL of 0.5 μM pyranine solution was placed in a cuvette with 15 g of enTMOS nanoparticles and shaken about 3 times. The cuvette was then placed in a Perkin Elmer LS 55 Luminescent Spectrometer and automatic spectrum measurements were obtained every 15 seconds over a period of 30 minutes. This experiment was repeated using 3 mL of 0.5 μM rhodamine dye combined with 15 g of carboxylate nanoparticles. The spectrometer settings used to obtain spectral measurements for each trial are summarized in Table 1 below.

TABLE 1
Florescent Spectrometer Settings for
Fluorescent Absorption Time Trials

| | |
|---|---|
| enTMOS Trial | Carboxylate Trial |

| | | | | |
|---|---|---|---|---|
| Start Time | 450 | nm | 540 | nm |
| End Time | 750 | nm | 700 | nm |
| Excitation | 440 | nm | 530 | nm |
| Exit Slit | 3.1 | nm | 3.1 | nm |
| Entry Slit | 3.1 | nm | 3.1 | nm |

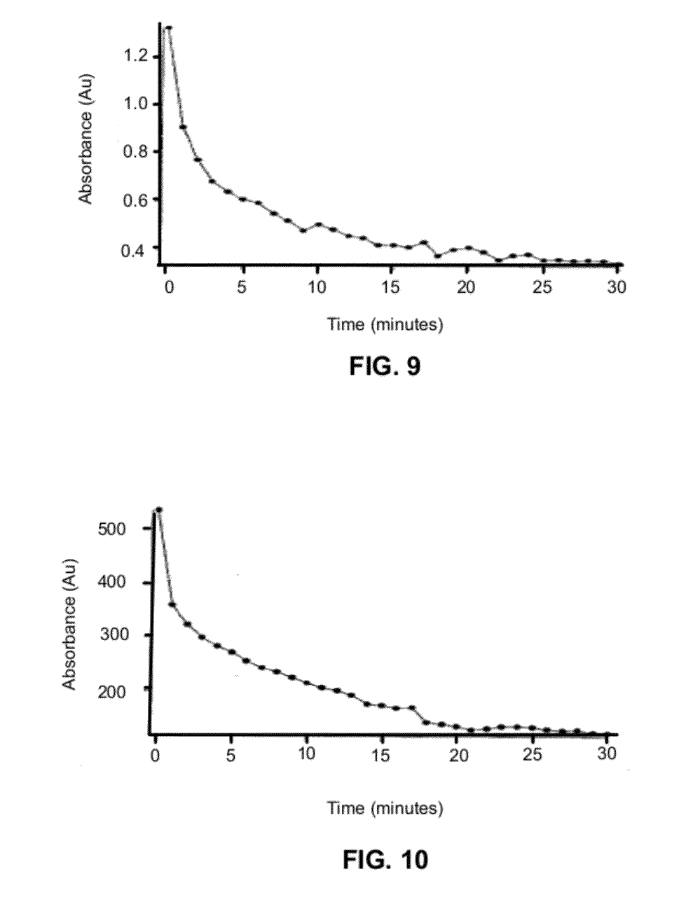

FIG. 9 is a summary of the rhodamine dye concentration as a function of time after the addition of the carboxylate nanoparticles, and FIG. 10 is a summary of the pyranine dye concentration as a function of time after the addition of enTMOS nanoparticles. In both cases, the absorption rate was initially rapid and then slowed with time as the dyes became less concentrated and the nanoparticles became more saturated with dye. The carboxylate nanoparticles absorbed the dye at a higher rate than the enTMOS nanoparticles.

The results of this experiment indicated that the nanoparticle absorbents absorb molecules in a concentration-dependent manner, with a higher initial rate that gradually slows over time.

### Example 5

### Solute Absorption by Syringe Filters Containing Electrostatically-Charged Nanoparticles

To assess the feasibility of absorbing solute out of a solution using a syringe filter that incorporated electrostatically-charged nanoparticles, the following experiments were conducted. Absorption spectrographic measurements were obtained on various dye compositions before and after running the compositions through a syringe filter to assess the efficacy of the syringe filter devices.

A quantity of carboxylate nanoparticles similar to those produced in Example 1 was obtained for inclusion in one set of syringe filters. In addition, a quantity of DT particles was created from a ground gel produced using a sol-gel technique similar to the technique described in Example 1. A solution was created by combining 2 mL of de-ionized water, 2 mL of ethanol, 1 mL of 3-trimethylsilypropyl-diethylenetriamine (DT) (Gelest), and 1 mL of tetraethyl orthosilicate (TEOS) (Aldrich Chemical, USA) in sequential order. The resulting mixture was stirred for approximately 1.5 hours. The solution was initially tan and clear (due to the coloring of the DT solution), but after several minutes the solution became turbid and began to get thick and goopy, indicating the formation of suspended particles. Once stirring was complete, the mixture was then put into a 53° C. oven for at least 15 hours. After this time the solution became a brown gel that was then broken up, re-dried, and finely ground. The resulting DT nanoparticles became whiter in color as they were ground, but still retained a slight brown tint.

To produce the syringe filters, circles with a diameter of approximately 0.75 cm cut out from Whatman filter paper using the rubber tip of a plunger from a 3 cc BD syringe as a template. Two pieces of the filter paper were inserted into the 3 cc syringe and then pushed tightly down with the syringe plunger. Approximately 55 mg of carboxylate or DT nanoparticles were added to the syringe and tapped lightly to ensure an even distribution of nanoparticles across the surface of the filter paper. Another layer of filter paper was then inserted over the layer of nanoparticles, and the plunger was used to pack the syringe filter assembly tightly together.

A dye mixture was created from 2 mL of 0.05 mM methylene blue and 2 mL of 0.05 mM phenol red. After obtaining a UV-Vis spectrum of the dye mixture, the mixture was loaded into the barrel of a syringe containing a carboxylate-loaded syringe filter and forced out through the filter using the syringe plunger. The filtered dye mixture was collected and subjected to a second spectrum measurement. This experiment was then repeated using a DT particle syringe.

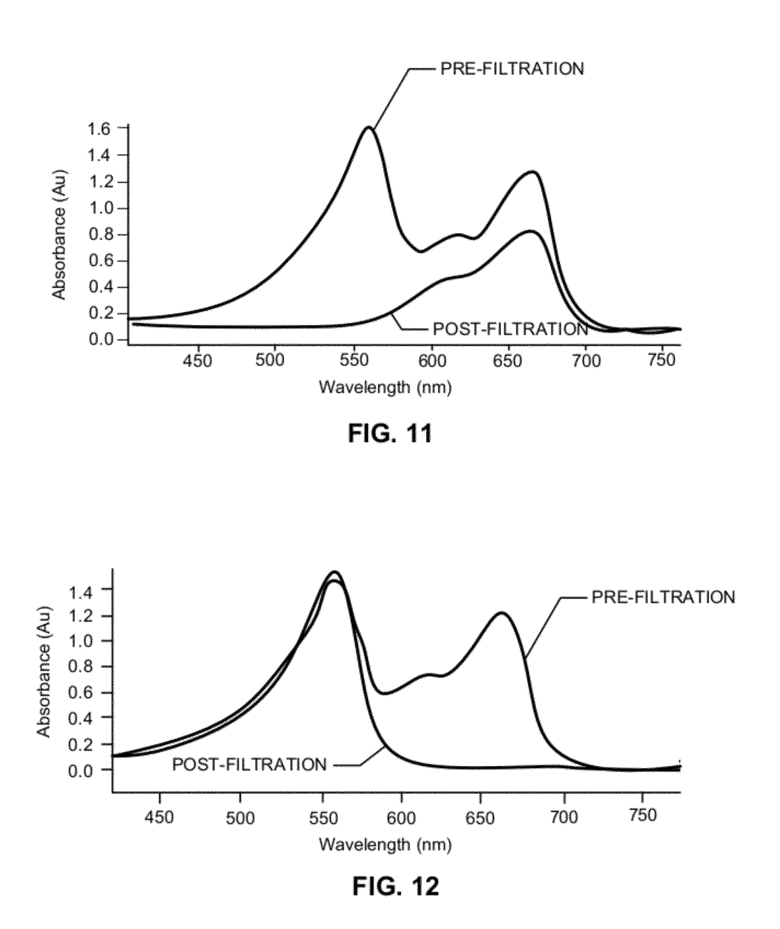

FIG. 11 is a comparison of the spectra of the methylene blue/phenol red dye mixture before and after filtration using a carboxylate syringe filter. The carboxylate nanoparticles were able to absorb the positively charged methylene blue dye and allowed only phenol red dye to pass through the filter. After filtration, there was almost no more blue dye left in solution, as evidenced by the reduction in the left-hand spectral peak corresponding to the methylene blue dye. The right-hand spectral peaks corresponding to the phenol red dye showed no significant change. Visually, the dye that entered the syringe was purple-colored and the solution leaving the syringe filter was pink-colored.

The DT nanoparticles were able to filter out the phenol red dye effectively as well. FIG. 12 shows a comparison of the spectra of the methylene blue/phenol red dye mixture before and after filtration using a DT syringe filter. The spectra show that all the phenol red dye was absorbed by the particles and only methylene blue dye remained in solution after filtration by the DT syringe filter, as evidenced by the significant reduction in the right-hand spectral peak corresponding to the phenol red dye. There is a slight decrease in the intensity of the left-hand spectral peak corresponding to the methylene blue dye after filtration, most likely due to interactions between the charged dye and the charged filter paper that was used in the syringe filter assembly. The Whatman filter paper carried a negative charge and may have absorbed some of the blue dye passing through, causing the right spectral peak to decrease slightly. Visually, the original solution had a purple color before filtration than changed to a pale blue color after filtration.

When the dye solutions were allowed to passively trickle through the filter by diffusion, a different filtration efficacy was observed. Initially, the dye solutions would exhibit similar color changes and absorption patterns as the instantaneous filtration described above, but eventually contamination of the syringe filter would occur and the final filtrated solution would emerge with a purple color. This reduction in filtration efficacy may be a consequence of the longer time it takes for the solution to trickle through the syringe filter. During this trickle time, the nanoparticles may become saturated with dye. Alternatively, prolonged exposure of the syringe filter to the dye solution may have a deteriorating effect on the filter.

The results of these experiments demonstrated that the syringe filters made with carboxylate and DT nanoparticles were able to separate dyes in an instantaneous fashion.

### Example 6

### Formation of Nanoparticle-Coated Textile Materials

To demonstrate the feasibility of producing textile materials that incorporate nanoparticulate absorbents, the following experiments were conducted.

To form a carboxylate-coated textile material, the following solutions were combined in a plastic beaker and stirred for approximately one hour: 25 mL deionized water, 25 mL ethanol, 5 mL TMOS, and 1 mL carboxylate. After one hour of stirring, the mixture was diluted with an additional 450 mL of de-ionized water. Three pieces of a textile material were dipped into this solution, wrung out slightly, and dried in a dryer. The dried carboxylate-coated textile materials were laid out on a lab bench that had been sterilized with ethanol.

To form an enTMOS-coated textile material, 500 μL of enTMOS precursor as described in Example 1 above was combined with 50 mL of de-ionized water and stirred for approximately 20 minutes. After 20 minutes of stirring the solution was diluted with an additional 450 mL of de-ionized water and three pieces of a textile material were dipped into the resulting solution. After being wrung out, the textiles were dried in the dryer and laid out on a lab bench that had been sterilized with ethanol.

The following experiments demonstrated the feasibility of producing textile materials coated with nanoparticulate absorbent materials.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A molecular filtration device comprising at least one membrane filter element, wherein the membrane filter element comprises an organosilicate material.

2. The device of claim 1, wherein the organosilicate material is chosen from the group including tetramethyl orthosilicate, tetraethyl orthosilicate, bis[3-(trimethoxysilyl)propyl]ethylenediamine, 3-trimethylsilylpropyl diethylenetriamine, tetraethyl orthosilicate, carboxylethylsilanetriol, 3-aminopropyl trimethoxysilane, 3-(triethoxysilyl)propyl succinic anhydride, 3-trihydroxysilylpropylmethylphosphonate, 3-(trihydroxysilyl)-1-propanesulfonic acid, and any combination thereof.

3. The device of claim 1, wherein the at least one membrane filter element is a sol-gel membrane comprising the organosilicate material.

4. The device of claim 1, wherein the membrane filter element further comprises an upper membrane support and a lower membrane support, wherein a plurality of particles comprising the organosilicate material are situated between the upper membrane support and the lower membrane support.

5. The device of claim 4, wherein the upper membrane support and the lower membrane support are independently chosen from a frit, a mesh, a screen, a fabric, or a porous membrane.

6. The device of claim 4, wherein the molecular filtration device is a syringe filter comprising the plurality of particles, upper membrane support, and lower membrane support situated within a barrel of a syringe.

7. The device of claim 1, wherein the membrane filter element further comprises a filter structure, wherein the filter structure is coated with the organosilicate material.

8. The device of claim 1, wherein the filter structure comprises a frit, a mesh, a screen, filter paper, or a fabric.

9. The device of claim 1, wherein the organosilicate material defines a plurality of pores, wherein the pores have pore diameters ranging from about 1 nm to about 100 nm.

10. The device of claim 7, wherein the pore diameters range from about 1 nm to about 20 nm.

11. A filtration membrane disc comprising an organosilicate material, wherein the organosilicate material is in the form of a sol-gel.

12. The filtration membrane disc of claim 9, wherein the organosilicate material is chosen from the group including tetramethyl orthosilicate, tetraethyl orthosilicate, bis[3-(trimethoxysilyl)propyl]ethylenediamine, 3-trimethylsilylpropyl diethylenetriamine, tetraethyl orthosilicate, carboxylethylsilanetriol, 3-aminopropyl trimethoxysilane, 3-(triethoxysilyl)propyl succinic anhydride, 3-trihydroxysilylpropylmethylphosphonate, 3-(trihydroxysilyl)-1-propanesulfonic acid, and any combination thereof.

13. The filtration membrane disc of claim 10, wherein the disc has a thickness ranging from about 1 mm to about 1 cm.

14. A method of removing a molecule from an aqueous solution comprising the molecule, comprising introducing the aqueous solution into a molecular filtration device comprising at least one filtration element, wherein the at least one filtration element comprises an organosilicate material.

15. The method of claim 14, wherein the organosilicate material is chosen from the group including tetramethyl orthosilicate, tetraethyl orthosilicate, bis[3-(trimethoxysilyl)propyl]ethylenediamine, 3-trimethylsilylpropyl diethylenetriamine, tetraethyl orthosilicate, carboxylethylsilanetriol, 3-aminopropyl trimethoxysilane, 3-(triethoxysilyl)propyl succinic anhydride, 3-trihydroxysilylpropylmethylphosphonate, 3-(trihydroxysilyl)-1-propanesulfonic acid, and any combination thereof.

16. The method of claim 14, wherein the organosilicate material defines a plurality of pores, wherein the pores have pore diameters ranging from about 1 nm to about 20 nm.

17. The method of claim 14, wherein the organosilicate material selectively attracts the molecule by one or more attractive interactions between the molecule and the organosilicate material, wherein the one or more attractive interactions are chosen from electrostatic interactions, hydrophilic interactions, hydrophobic interactions, hydrogen-bonding interactions, van der Waals interactions, and any combination thereof.

18. The method of claim 17, wherein the organosilicate material has an electrostatic charge opposite that of the molecule.

19. The method of claim 17, wherein the attractive interactions may be modulated the application of one or more external stimuli to the organosilicate material, wherein the one or more external stimuli are chosen from pH of the aqueous solution, temperature of the aqueous solution, concentration of dissolved salts in the aqueous solution, an electrical field applied to the organosilicate material, a magnetic field applied to the organosilicate material, and any combination thereof.

20. The method of claim 14, wherein the molecule has a molecular weight ranging from about 1000 Daltons to about 10,000 Daltons.
